(19) United States
(12) Patent Application Publication
(10) Pub. No.: US 2016/0321748 A1
(43) Pub. Date: Nov. 3, 2016

(54) METHOD FOR MARKET RISK ASSESSMENT FOR HEALTHCARE APPLICATIONS

(71) Applicant: INTERNATIONAL BUSINESS MACHINES CORPORATION, Armonk, NY (US)

(72) Inventors: Shilpa Mahatma, Yorktown Heights, NY (US); Aleksandra Mojsilovic, Yorktown Heights, NY (US); Karthikeyan Natesan Ramamurthy, Yorktown Heights, NY (US); Kush R. Varshney, Yorktown Heights, NY (US); Dennis Wei, Yorktown Heights, NY (US); Gigi Yuen-Reed, Tampa, FL (US)

(21) Appl. No.: 14/699,482

(22) Filed: Apr. 29, 2015

(51) Int. Cl. G06Q 40/04; G06F 19/00

(52) U.S. Cl. CPC G06Q 40/04; G06F 19/328

(57) ABSTRACT

Exemplary embodiments of the present invention provide a method of health insurance market risk assessment including receiving first data including demographic and cost data for members of a health insurance plan in a current market, receiving second data including demographic data for the current market, and receiving third data including demographic data for a new market. The first to third data are used to transform a distribution of the plan members to account for differences between the current and new market demographic data and to estimate probabilities of enrollment in the new market. A statistical model is learned to predict risk in the new market using the transformed distribution and the estimated probabilities. The statistical model is used to determine risk of entering the new market.

### FIELD OF THE INVENTION

Exemplary embodiments of the present invention relate to market risk assessment. More particularly, exemplary embodiments of the present invention relate to market risk assessment for healthcare applications.

### DISCUSSION OF RELATED ART

Generally, health insurance companies seek to enter new healthcare markets having individual enrollees with relatively low annual costs who are likely to enroll in offered health insurance plans. However, healthcare cost data for new markets is generally unavailable prior to entering such a new market, and thus the risk of entering a new market may be difficult to determine. Although not typically done by health insurance companies today, regression methods, such as ordinary least-squares regression with and without log-transformed data, two-part models, generalized linear models, and multiplicative regression, may be used to assess risk in a new market by estimating healthcare cost based on demographic data, which may be publicly available. Furthermore, current regression techniques may take into consideration demographic differences between the new market and an insurance company's existing market. However, current techniques do not account for additional subpopulations within the existing and new markets, specifically the members of a health insurance plan in the existing market and prospective enrollees in the plan in the new market. Therefore existing methods may produce inaccurate or limited models for market risk assessment.

Medical and healthcare related data of individuals is protected in the United States by the Health Insurance Portability and Accountability Act (HIPAA). HIPAA requires that medical and healthcare data, even when used internally within an insurance company, must not be compromised. Therefore, methods have been developed for anonymization of medical and healthcare data. However, anonymization of medical and healthcare data may reduce the predictive accuracy of risk assessment methods. Thus, a need exists for a method of healthcare market risk assessment including anonymization of medical and healthcare data without a substantial reduction in the predictive accuracy of the healthcare market risk assessment method.

### SUMMARY

Exemplary embodiments of the present invention provide a method of health insurance market risk assessment including receiving first data including demographic and cost data for members of a health insurance plan in a current market, receiving second data including demographic data for the current market, and receiving third data including demographic data for a new market. The first to third data are used to transform a distribution of the plan members to account for differences between the current and new market demographic data and to estimate probabilities of enrollment in the new market. A statistical model is learned to predict risk in the new market using the transformed distribution and the estimated probabilities. The statistical model is used to determine risk of entering the new market.

According to an exemplary embodiment of the present invention a privacy-preserving transformation on the first data may be performed.

According to an exemplary embodiment of the present invention the privacy-preserving transformation may include a k-member clustering followed by a probability transformation.

According to an exemplary embodiment of the present invention the transformation of the distribution of the plan members and the estimate of the probabilities of enrollment in the new market may occur at substantially the same time.

According to an exemplary embodiment of the present invention the estimates of the enrollment probabilities may be modified.

According to an exemplary embodiment of the present invention the estimates of the enrollment probabilities may be displayed to and may be modified by a user.

According to an exemplary embodiment of the present invention the statistical model may be learned using a non-demographic factor of the new market.

According to an exemplary embodiment of the present invention the statistical model may be used to produce individual-level cost predictions of entering the new market.

According to an exemplary embodiment of the present invention the individual-level cost predictions may be aggregated according to user-defined criteria.

Exemplary embodiments of the present invention provide a method of health insurance market risk assessment including transforming a distribution of existing plan members to account for differences between existing and new market demographics while estimating and accounting for probabilities of enrollment in the new market. A statistical model is learned to predict risk in the new market using the transformed distribution and the estimated probabilities. The statistical model is used to determine risk of entering the new market.

According to an exemplary embodiment of the present invention the method of health insurance market risk assessment includes receiving adjustments to initially estimated enrollment probabilities.

According to an exemplary embodiment of the present invention the adjustment is received from a subject matter expert.

According to an exemplary embodiment of the present invention using the statistical model to determine the risk of entering the new market includes computing individual-level cost predictions.

According to an exemplary embodiment of the present invention the method of health insurance market risk assessment includes aggregating the individual-level cost predictions according to user-defined criteria.

According to an exemplary embodiment of the present invention the statistical model includes a plurality of predictive values.

According to an exemplary embodiment of the present invention the method of health insurance market risk assessment includes applying a privacy preservation measure to data indicative of the existing plan members.

According to an exemplary embodiment of the present invention the privacy preservation measure is applied to the data which has already been removed of personal identifiers.

Exemplary embodiments of the present invention provide a method of health insurance market risk assessment including aggregate claims of current members of a health insurance plan to estimate demographic distribution of the current members. For each demographic group in the estimated demographic distribution of the current members, aggregate statistics of corresponding health costs are computed. Demographic data for the current member's market are aggregated to estimate a demographic distribution of a current market. Demographic data for the current member's market is aggregated to estimate a demographic distribution of the new market. Demographic data for a new market is aggregated to estimate a demographic distribution of the new market. For each demographic group of the estimated demographic distribution of the current market and the estimated demographic distribution of the new market, a ratio of new market distribution is computed. The aggregated claims of the current members and the aggregated statistics of the corresponding health costs are re-aggregated using the ratio of new market distribution. A model for predicting risk of entering the new market is learned by performing a linear regression of cost on demographic variables using the re-weighted aggregated claims of the current members and the aggregated statistics of the corresponding health costs.

According to an exemplary embodiment of the present invention the method of health insurance market risk assessment includes adjusting predictions made by the learned model by multiplying the predictions with a cost factor for the new market.

According to an exemplary embodiment of the present invention the method of health insurance market risk assessment includes aggregating the adjusted predictions according to pre-defined criteria.

### BRIEF DESCRIPTION OF THE FIGURES

The above and other features of the present invention will become more apparent by describing in detail exemplary embodiments thereof, with reference to the accompanying drawings, in which:

FIG. 1 is a flow chart of a method of health insurance market risk assessment according to an exemplary embodiment of the present invention.

FIG. 2 is a diagram illustrating a method of health insurance market risk assessment according to an exemplary embodiment of the present invention.

FIG. 3 is a block diagram illustrating a method for achieving k-anonymity and distribution preservation according to an exemplary embodiment of the present invention.

FIG. 4a illustrates prediction bias as a function of an anonymity parameter (k) for baseline, logistic shift and non-parametric shift methods with distribution preservation according to exemplary embodiments of the present invention.

FIG. 4b illustrates R² coefficient as a function of an anonymity parameter (k) for baseline, logistic shift and non-parametric shift methods with distribution preservation according to exemplary embodiments of the present invention.

FIG. 5a illustrates prediction bias as a function of an anonymity parameter (k) for baseline, logistic shift and non-parametric shift methods without distribution preservation.

FIG. 5b illustrates R² coefficient as a function of an anonymity parameter (k) for baseline, logistic shift and non-parametric shift methods without distribution preservation.

FIG. 6a illustrates a similarity between baseline, logistic shift and non-parametric shift estimated new enrollment distributions with distribution preservation according to exemplary embodiments of the present invention compared with actual new enrollment distributions as a function of an anonymity parameter (k).

FIG. 6b illustrates a similarity between baseline, logistic shift and non-parametric shift estimated new enrollment distributions without distribution preservation compared with actual new enrollment distributions as a function of an anonymity parameter (k).

FIG. 7 illustrates an exemplary interactive user dashboard according to exemplary embodiments of the present invention.

FIG. 8 illustrates an example of a computer system capable of implementing the method and apparatus according to embodiments of the present disclosure.

### DETAILED DESCRIPTION

Health insurance companies seek to enter new healthcare markets having individual enrollees with relatively low annual costs who are likely to enroll in offered health insurance plans. According to exemplary embodiments of the present invention, a three population shift may be used to assess risk in a new healthcare market. Exemplary embodiments of the present invention provide a probability-constrained, density-preserving quantization method for medical and healthcare data anonymization.

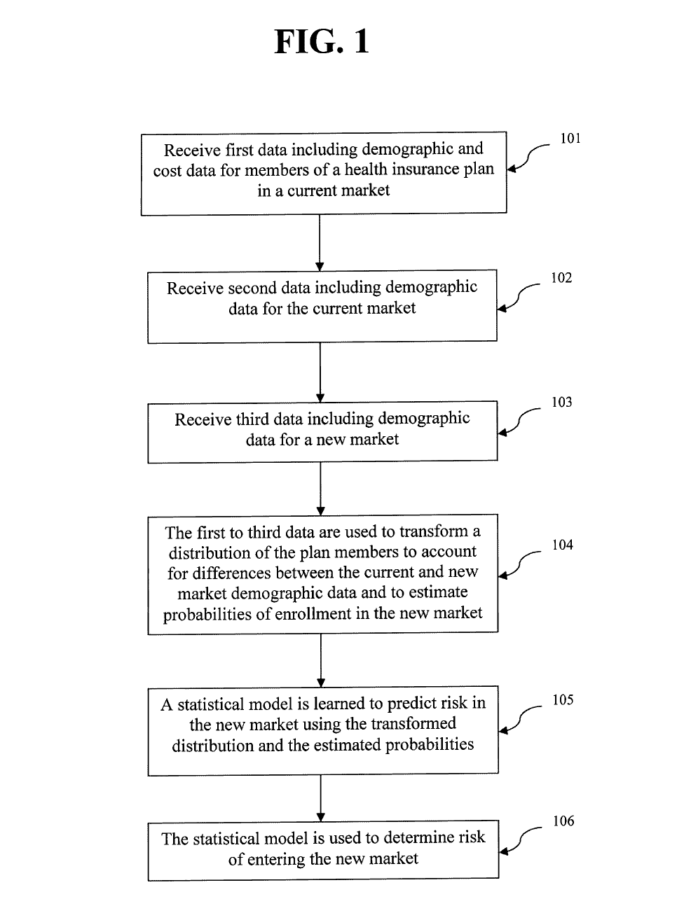

FIG. 1 is a flow chart of a method of health insurance market risk assessment according to an exemplary embodiment of the present invention.

Exemplary embodiments of the present invention provide a computer-based method of health insurance market risk assessment including receiving first data including demographic and cost data for members of a health insurance plan in a current market 101, receiving second data including demographic data for the current market 102, and receiving third data including demographic data for a new market 103. The first data 101, second data 102 and third data 103 are used to transform a distribution of the plan members to account for differences between the current and new market demographic data and to estimate probabilities of enrollment in the new market 104. A statistical model is learned to predict risk in the new market using the transformed distribution and the estimated probabilities 105. The statistical model is used to determine risk of entering the new market 106. According to an exemplary embodiment of the present invention a privacy-preserving transformation on the first data may be performed. According to an exemplary embodiment of the present invention the privacy-preserving transformation may include a k-member clustering followed by a probability transformation. It is to be understood that some or all of the steps shown in FIG. 1 may be performed automatically by a computer. For example, after receiving the first, second and third data 101-103, the computer may transform the distribution of the plan members and learn the statistical model automatically without user input.

Cost data for members of the health insurance plan 101 may be determined according to claims filed by current members. The claims may be examined according to at least one demographic dimension to estimate demographic distribution of current members. For example, demographic dimensions may include age, sex, ethnicity, marital status, education and/or income.

The demographic data for the current market 102 may be used to estimate demographic distribution for the current market. The demographic data for the new market 103 may be used to estimate demographic distribution for the new market. The first data including demographic and cost data for members of a health insurance plan in the current market 101, the second data including demographic data for the current market 102, and the third data including demographic data for a new market 103 may be used to transform a distribution of the plan members to account for differences between the current and new market demographic data and to estimate probabilities of enrollment in the new market 104 by performing a three-population shift. The three-population shift may be performed according to Formula 7, or according to a logistic regression model described in more detail below.

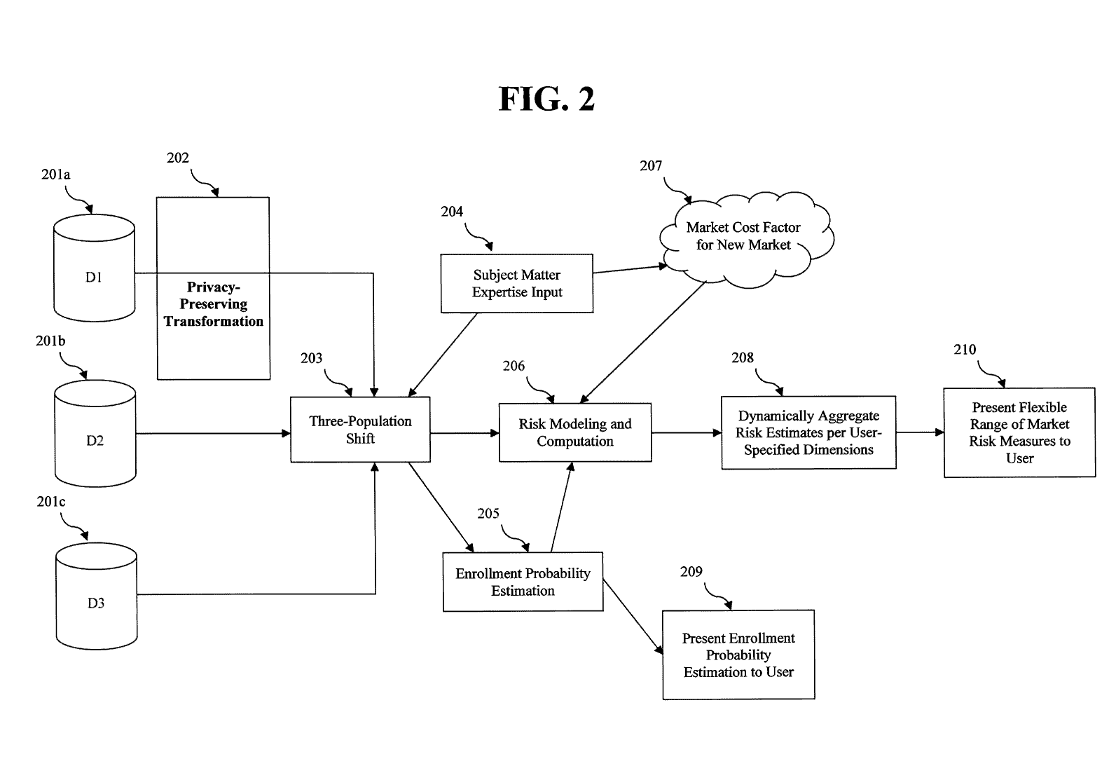

FIG. 2 is a diagram illustrating a method of health insurance market risk assessment including a privacy-preserving transformation according to an exemplary embodiment of the present invention.

Referring to FIG. 2, individual demographic and cost data for an insurer's current members enrolled in an existing plan 201a, demographic data for member population's market at-large (the current market) 201b and demographic data for a new market 201c may undergo the three-population shift 203. The three population shift 203 is described in more detail below with reference to Formula 7. The three population shift may be performed according to an empirical (non-parametric method) or according to a logistic regression method, described in more detail below. The demographic data for member population's market at-large (the current market) 201b and the demographic data for a new market 201c may be market demographic data which is publically available. The three population shift 203 may transform the distribution of a current plan population to account for market demographics in the new market and enrollment probability in the new market may be estimated 205. The estimation of enrollment probability in the new market may be presented to a user 209 following the three-population shift according to exemplary embodiments of the present invention.

The user may input market cost factors for a new market 207. Market cost factors may include insights into the new market, such as enrollment probability assumptions, which have not been accounted for in the variables included in the three population shift. A subject-matter expert may input subject matter expertise 204 into a risk modeling and computation step 206. For example, a subject matter expert may modify enrollment predictions based on competition between insurers in the new market.

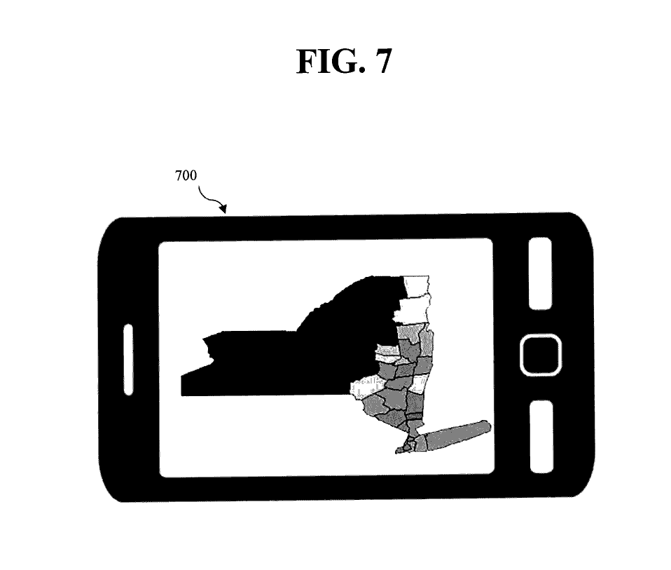

The estimation of enrollment probability 205 having undergone the three-population shift 203 and/or subject matter expertise input 204 may be combined to predict cost for the new market 206. Risk estimates for the new market may be dynamically aggregated according to desired dimensions 208. For example, market risk assessment may be determined according to individual level granularity or population level granularity. A range of market risk measures may be presented to the user 210. For example, as illustrated in FIG. 7 and discussed in more detail below, a flexible range of market risk measures may be presented to a user 210 in a user risk dashboard 700. For example, market risk measures may be dynamically presented to a user on a computer, tablet or Smartphone.

A new market may include a specific geographic area, a new base of prospective clients, or a particular industry population. Demographic data for the new market may include gender, age, languages, disabilities, home ownership, educational attainment, military service, socioeconomic status, or employment status, for example. Demographic data for an insurer's current market may be different than demographic data for a prospective new market of interest to the insurer. The differences in demographic data for the new and existing markets may represent a demographic shift. According to an exemplary embodiment of the present invention the statistical model may be learned using a non-demographic factor of the new market.

Referring to FIG. 2, a privacy-preserving transformation 202 may be optionally performed on the individual demographic and cost data for an insurer's current members enrolled in an existing plan 201a, the demographic data for member population's market at-large (the current market) 201b and/or the demographic data for a new market 201c, as discussed below in more detail. The privacy-preserving transformation 202 may be more than simple de-identification. The privacy-preserving transformation 202 may preserve data distributions to reduce or eliminate an impact on predictive accuracy for models employing the transformed data.

According to exemplary embodiments of the present invention, a predictive analytic approach is described in which the relationship between demographics and costs in the current member population is learned and the learned model is applied to the new market demographic data, taking into account the difference between the demographic distribution of the current member population and the demographic distribution of the prospective enrollees in the new market. This setting may be referred to as a covariate shift in a machine learning context. The concept of a covariate shift is described in more detail below.

### Covariate Shift Problem

A covariate shift problem may occur when analyzing data. As discussed below in more detail, a covariate shift problem may occur when predictor variables or covariates are drawn from a test distribution (e.g., a different distribution q_{X} in a test phase). An example of a covariate shift problem may occur when it is desired to predict response variable Y using predictor variables X. Given a class of functions F and training samples (xᵢ, yᵢ), i=1, . . . , n, a predictor function may be selected from F to minimize the empirical risk,

$$\hat{Y} ( \cdot ) = {arg min}_{f ∈ ℱ} \frac{1}{n} {\sum }_{i = 1}^{n} ℒ ( f ( {x}_{i} ) , {y}_{i} ) , \qquad ( Formula 1 )$$

for some choice of loss of function L that measures the error between the predicted response ƒ(xᵢ) and actual response yᵢ.

The training samples may be drawn i.i.d. from a joint distribution P_{X,Y}=P_{X}P_{Y}|_{X}. The problem of covariate shift may occur when the predictor variables or covariates are drawn from a different distribution q_{X} in the test phase. It may be assumed that the conditional distribution P_{Y}|_{X} remains the same. As the number of samples n approaches infinity (e.g. n→∞), the empirical risk in Formula 1 converges to the population risk

E[L(ƒ(X),Y)]=E[E[L(ƒ(X),Y)|X]],

from which the optimal choice of predictor ƒ may depend on the conditional distribution P_{Y}|_{X} regardless of the marginal distribution for X (e.g. p_{X} or q_{X}). As the number of samples n approaches infinity (e.g. n→∞), the conditional distribution P_{Y}|_{X} may be accurately learned and the optimal predictor may be obtained when the class of functions F is sufficient. When the number of samples n is finite and/or F is relatively limited, the predictor Ŷ resulting from Formula 1 may depend on the training distribution p_{X} and thus can be mismatched with respect to the test distribution q_{X} under which performance is evaluated.

A solution to the covariate shift problem is to weight the training samples by the ratio q_{X}(xᵢ)/p_{X}(xᵢ), which may represent the relative importance of each sample under q_{X} rather than p_{X}. The weighted empirical risk

$$\frac{1}{n} {\sum }_{i = 1}^{n} \frac{q x ( {x}_{i} )}{p x ( {x}_{i} )} ℒ ( f ( {x}_{i} ) , {y}_{i} )$$

may then converge to

$${𝔼}_{p X p Y \vert X} [ \frac{q x ( X )}{p x ( X )} ℒ ( f ( X ) , Y ) ] = {𝔼}_{q X p Y \vert X} [ ℒ ( f ( X ) , Y ) ] , \qquad ( Formula 2 )$$

which may match the test distribution.

According to an exemplary embodiment of the present invention, the predictor variables X may be discrete-valued each other. Thus, the values of predictor variables X may be taken as a set χ. The probability mass functions (PMFs) of interest may be approximated by the empirical distributions \hat{p}_{X}(X), \hat{q}_{X}(X) and their ratio \hat{q}_{X}(X)/\hat{p}_{X}(X). According to an exemplary embodiment of the present invention the weighted empirical risk may be rewritten as an outer sum over χ and an inner sum over training samples with common xᵢ=x according to Formula 3 below:

$${\sum }_{x \text{:} {\hat{p}}_{X} ( x ) > 0} {\hat{p}}_{X} ( x ) \frac{{\hat{q}}_{X} ( x )}{{\hat{p}}_{X} ( x )} \frac{1}{n ( x )} {\sum }_{i \text{:} {x}_{i} = x} ℒ ( f ( x ) , {y}_{i} ) = {\sum }_{x \text{:} {\hat{p}}_{X} ( x ) > 0} {\hat{q}}_{X} ( x ) \frac{1}{n ( x )} {\sum }_{i \text{:} {x}_{i} = x} ℒ ( f ( x ) , {y}_{i} ) , \qquad ( Formula 3 )$$

n(x) may be the number of training samples with xᵢ=x. Thus, the weighted empirical risk of Formula 3 converges to Formula 2 as n approaches infinity (e.g. n→∞).

### Market Risk Assessment

It may be possible to apply the covariate shift framework described above if enough information is known about potential enrollees in a new market. This case may be referred to as a two population market shift problem. The covariate shift framework described above may be used for market risk assessment, such as analyzing health care costs for a prospective market. When applying the covariate shift framework described above, the response variable Y may be an annual cost of a member to an insurance company. The predictor variables X may be demographic variables such as age, gender, income, veteran status, smoking status, place of residence, and/or place of origin.

The covariate shift problem described above may be modified according to exemplary embodiments of the present invention to assess market risk by using a three-population shift method. Two such three-population shift methods for assessment of market risk are described in more detail below; an empirical method and a logistic regression method.

### Empirical Method (Non-Parametric Method)

The variable E may refer to enrollment in an insurance company's plan (e.g., E=1 means enrolled). The variable M may differentiate an existing current market from a new market (e.g., M=1 means new market).

Training data with costs may come from an insurance company's data on current plan members. The training distribution p_{X} described above may be p_{X}|E,M (x|e=1, m=0), referring to enrollees in the current market. The test distribution q_{X} may be p_{X}|E,M (x|e=1, m=1), referring to enrollees in the new market. In the three population shift method, it is assumed that p_{X}|E,M (x|e=1, m=1) cannot be directly measured, however, demographic distributions for the current market and the new markets are available. p_{X}|M (x|0) represents demographic distributions for the current market and p_{X}|M (x|1) represents demographic distributions for the new market(s) in Formula 4 below, which are related to Bayes' rule.

$${p}_{X \vert E , M} ( x \vert 1 , m ) = \frac{{p}_{E \vert X , M} ( 1 \vert x , m ) {p}_{X \vert M} ( x \vert m )}{{p}_{E \vert M} ( 1 \vert m )} , m = 0 , 1. \qquad ( Formula 4 )$$

Taking the ratio of m=1 to m=0 gives Formula 5

$$\frac{{p}_{X \vert E , M} ( x \vert 1 , 1 )}{{p}_{X \vert E , M} ( x \vert 1 , 0 )} ∝ \frac{{p}_{E \vert X , M} ( 1 \vert x , 1 )}{{p}_{E \vert X , M} ( 1 \vert x , 0 )} \frac{{p}_{X \vert M} ( x \vert 1 )}{{p}_{X \vert M} ( x \vert 0 )} \qquad ( Formula 5 )$$

as a function of x, which may be used to predict a probability of enrollment.

It may be assumed that pE|X,M (1|x,m), i.e., the probability of enrollment conditioned on the predictor variables and the market, may be independent of the market m once x is fixed. In other words, E and M may be conditionally independent given

X and pE|X,M (1|x,m)=pE|X (1|x). Assuming X and pE|X,M (1|x,m)=pE|X (1|x), conditional independence may be simplified as Formula 6.

$${p}_{X \vert E , M} ( x \vert 1 , 1 ) ∝ {p}_{X \vert E , M} ( x \vert 1 , 0 ) \frac{{p}_{X \vert M} ( x \vert 1 )}{{p}_{X \vert M} ( x \vert 0 )} . \qquad ( Formula 6 )$$

Since the training samples are distributed according to p_{X}|E,M (x|1,0) and the test samples are distributed according to p_{X}|E,M (x|1,1), the importance weighting is therefore p_{X}|M^{(x|1)}/p_{X}|M^{(x|0)} (up to a constant of proportionality). p_{X}|M^{(x|1)}/p_{X}|M^{(x|0)} may take the place of q_{X}(x)/p_{X}(x) in the covariate shift problem described above. Thus, the weighted empirical risk formally becomes Formula 7.

$${\sum }_{x} {\hat{p}}_{X \vert E , M} ( x \vert 1 , 0 ) \frac{{\hat{p}}_{X \vert M} ( x \vert 1 )}{{\hat{p}}_{X \vert M} ( x \vert 0 )} \frac{1}{n ( x )} {\sum }_{i \text{:} {x}_{i} = x} ℒ ( f ( x ) , {y}_{i} ) \qquad ( Formula 7 )$$

Referring again to FIG. 2, individual demographic and cost data for an insurer's current members enrolled in an existing plan 201a, demographic data for member population's market at-large (the current market) 201b and demographic data for a new market 201c may undergo the three-population shift 203 according to Formula 7. The three-population shift 203 may transform the distribution of a current plan population to account for market demographics in the new market and enrollment probability in the new market may be estimated 205.

### Logistic Regression Method

When χ is relatively large or when there is a continuous X, estimating p_{X}(x), q_{X}(x) and/or their ratio may become difficult. Thus, a parametric method (e.g., a method in which a value of one or more parameters is assumed for the purpose of analysis), such as a logistic regression method, may be employed to assess market risk. According to an exemplary embodiment of the present invention, the logistic regression model may be used as a parametric method for estimating the probability ratio q_{X}(x)/p_{X}(x) or p_{X}|M^{(x|1)}/p_{X}|M^{(x|0)}. The logistic regression model may be trained to decide between the existing market M=0 and the new market M=1 given the covariate x, using demographic data for both the old market and the new market. According to an exemplary embodiment of the present invention, the logistic regression model may yield a parametric form for the conditional probability of belonging to the old and/or new market according to the following equation:

$${p}_{M \vert X} ( 1 \vert x ) = \frac{1}{1 + {e}^{- {β}^{T} x}} , {p}_{M \vert X} ( 0 \vert x ) = \frac{{e}^{- {β}^{T} x}}{1 + {e}^{- {β}^{T} x}} .$$

An application of Bayes' rule shows that

$${e}^{{β}^{T} x} = \frac{{p}_{M \vert X} ( 1 \vert x )}{{p}_{M \vert X} ( 0 \vert x )} ∝ \frac{{p}_{X \vert M} ( x \vert 1 )}{{p}_{X \vert M} ( x \vert 0 )}$$

as functions of x. Thus, the desired probability ratio is given by by e^{β}^{^{T}}^{x}, which may be the exponential of a linear function of x.

### K-Anonymity and Privacy Preservation

One statistical interpretation of individual data privacy requirements under the Health Insurance Portability and Accountability Act (HIPAA) is k-anonymity. Under a k-anonymity privacy model, data for an individual cannot be distinguishable from at least k−1 other individuals. The purpose of k-anonymity may be to render data for an individual anonymous such that the individual who is the subject of the data cannot be identified, while allowing the data to remain practically useful for statistical analysis. k-anonymity is discussed in more detail in Sweeney, Latanya. “k-anonymity: A model for protecting privacy.” International Journal of Uncertainty, Fuzziness and Knowledge-Based Systems 10.05 (2002): 557-570; Samarati Pierangela. “Protecting respondents identities in microdata release.” Knowledge and Data Engineering, IEEE Transactions on 13.6 (2001): 1010-1027; Malin, Bradley, Kathleen Benitez, and Daniel Masys. “Never too old for anonymity: a statistical standard for demographic data sharing via the HIPAA Privacy Rule.” Journal of the American Medical Informatics Association 18.1 (2011): 3-10; Byun, Ji-Won, et al. “Efficient k-anonymization using clustering techniques,”Advances in Databases: Concepts, Systems and Applications. Springer Berlin Heidelberg, 2007. 188-200, the disclosures of which are incorporated by reference herein in their entireties.

k-anonymity may be achieved by using generalizations and suppression, however, treating anonymization as a clustering or grouping problem may provide greater flexibility than using pre-defined generalization hierarchies.

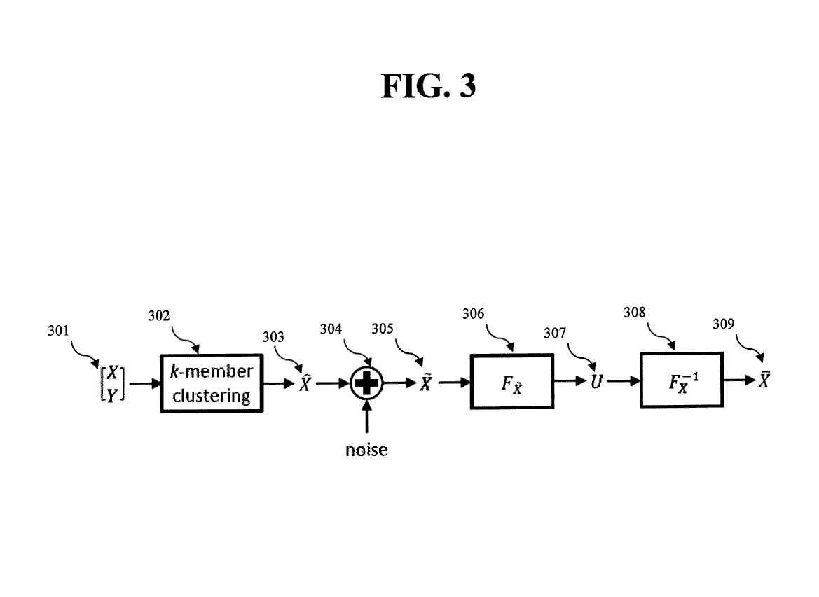

FIG. 3 is a block diagram illustrating a method for achieving k-anonymity and distribution preservation according to an exemplary embodiment of the present invention.

According to an exemplary embodiment of the present invention, k-anonymity may be achieved by grouping samples or records in data by similarity such that a smallest group may have at least k elements. The smallest grouping or clustering may be sufficient for privacy preservation. However, the quality of the grouping may be considered in terms of a workload for which the data is to be used. According to an exemplary embodiment of the present invention, the workload may be a three-population shift-based market risk prediction. In light of the workload according to exemplary embodiments of the present invention, a distribution-preserving quantization method may be employed as a grouping procedure for achieving k-anonymity.

According to exemplary embodiments of the present invention, a number of operations may be performed to achieve k-anonymity. According to exemplary embodiments of the present invention, x may be converted to another value x̅ 309, such that (xᵢ, yᵢ) map to (x̅ᵢ, yᵢ), as illustrated, for example, in FIG. 3. Distribution-preserving quantization may be performed, and may include dithering and transformation. The following operations may have relatively low aggregate prediction error of cost, relatively small bias and relatively large R². Bias may be a difference between mean predicted cost and mean actual cost.

Data may be clustered using a modified k-member clustering algorithm 302. Quasi-identifiers X and sensitive data Y may be grouped (e.g., clustered) 301. Thus, individuals with similar costs may be grouped together. Y may be dropped after final cluster assignments are determined. The output of k-member clustering may be \hat{x}ᵢ. All samples within a same cluster may share an \hat{x} value 303. The number of clusters may be

$$c = ⌊ \frac{n}{k} ⌋ ,$$

and j may index the clusters. The number of samples in cluster j may be nⱼ≧k.

An output set of the k-member clustering may include c distinct values that are not distributed like X. Dithering (e.g., the intentional application of noise) 304 may convert the data set to have n distinct values. Covariances of each of the clusters Σⱼ, j=1, . . . , c may be estimated and Gaussian noise N(0, Σ_{{j:i}_{^{ε}}_{clusterj}}+αI) may be added to each sample according to its cluster membership to produce values ^{˜}xᵢ. A cumulative distribution function (CDF) of 305 may be a Gaussian mixture with c mixture components according to Formula 8, and thus may not be distributed like X.

$${F}_{\tilde{X}} ( \tilde{x} ) = {{\sum }^{c}}_{j = 1} \frac{{n}_{j}}{n} Φ ( \tilde{x} ; {\hat{x}}_{j} , {\sum }_{j} + α I ) . \qquad ( Formula 8 )$$

The described transformation may be multivariate and thus a Rosenblatt transformation may be performed. Rosenblatt transformation is discussed in more detail in Rosenblatt, Murray. “Remarks on a multivariate transformation.” The annals of mathematical statistics (1952): 470-472, the disclosure of which is incorporated by reference herein in its entirety.

According to an exemplary embodiment of the present invention, the CDF of may be used to transform 306 into a uniformly distributed variable U 307 and then the inverse CDF of X to transform U to X̅, which may be distributed like X. Denoting the lth dimension of a vector with the subscript l,

U₁=F_{\tilde{X}}_{₁}(\tilde{X}₁)

U₂=F_{\tilde{X}}_{₂}_{|\tilde{X}}_{₁}(\tilde{X}₂|\tilde{X}₁)

Thus, the following Formula 9 is derived

U_{d}=F_{\tilde{X}}_{_{d}}_{|\tilde{X}}_{₁}_{, . . . ,\tilde{X}}_{_{d−1}}(\tilde{X}_{d}|\tilde{X}₁, . . . ,\tilde{X}_{d-1}) (Formula 9)

The conditional CDFs may be univariate Gaussian mixtures. The parameters of the conditional CDFs may be obtained in closed form from Formula 8. A second operation 308 may be performed, but in the second operation the inverse CDF of X may be represented by:

\tilde{X}₁=F_{X}_{₁}⁻¹(U₁)

\tilde{X}₂=F_{X}_{₂}_{|X}_{₁}⁻¹(U₂|U₁)

Thus, the following Formula 10 is derived:

\tilde{X}_{d}=F_{X}_{_{d}}_{|X}_{₁}_{, . . . ,X}_{_{d−1}}⁻¹(U_{d}|U₁, . . . ,U_{d-1}).

According to exemplary embodiments of the present invention, distribution-preserving quantization is an alternative method to standard k-means or standard quantization approaches. As discussed above, distribution-preserving quantization according to exemplary embodiments of the present invention may include subtractive dithered quantization followed by Rosenblatt's transformation.

### Health Cost Predictions

### Health Cost Predictions without Privacy Preservation

Exemplary results of health cost data according to exemplary embodiments of the present invention are discussed below in more detail according to the empirical method (non-parametric method) and the logistic regression method discussed above, both without the use of the privacy preservation method discussed above.

As illustrated in Table 1 below, both the empirical method (non-parametric method) and the logistic regression method may have a reduced bias when compared with a baseline (no shift) method. Table 1 illustrates a coefficient of determination (R²) and relative bias (%) for the logistic regression method and the non-parametric method according to exemplary embodiments of the present invention and the baseline comparative example (no shift).

TABLE 1

| | R² value | | | Relative Bias (%) | | |
|---|---|---|---|---|---|---|
| New Market | No Shift | Logistic | Non-param. | No Shift | Logistic | Non-param. |
| RA 2 | 0.0247 | 0.0225 | 0.0226 | 7.53 | 6.86 | 3.60 |
| RA 4 | 0.0270 | 0.0252 | 0.0252 | 4.42 | 3.90 | 2.63 |
| RA 6 | 0.0262 | 0.0243 | 0.0244 | 4.23 | 3.41 | 2.21 |
| RA 8 | 0.0251 | 0.0235 | 0.0233 | 4.14 | 3.18 | 1.93 |
| RA 10 | 0.0257 | 0.0242 | 0.0241 | 4.41 | 3.56 | 1.95 |
| RA 12 | 0.0259 | 0.0242 | 0.0243 | 4.57 | 3.74 | 1.91 |
| RA 14 | 0.0271 | 0.0253 | 0.0245 | 4.43 | 3.71 | 2.20 |
| RA 15-16 | 0.0291 | 0.0275 | 0.0283 | 2.53 | 2.28 | 0.32 |
| RA 18 | 0.0247 | 0.0245 | 0.0245 | 3.04 | 2.04 | 0.44 |

The baseline method may have a relative bias when compared with the logistic and the non-parametric methods. The logistic regression and non-parametric methods may reduce the relative bias. Relative bias may be reduced by shifting the distribution of existing plan members to predict prospective enrollees in the new market. The non-parametric method may reduce bias more than the logistic regression method.

Health Cost Predictions with Privacy Preservation

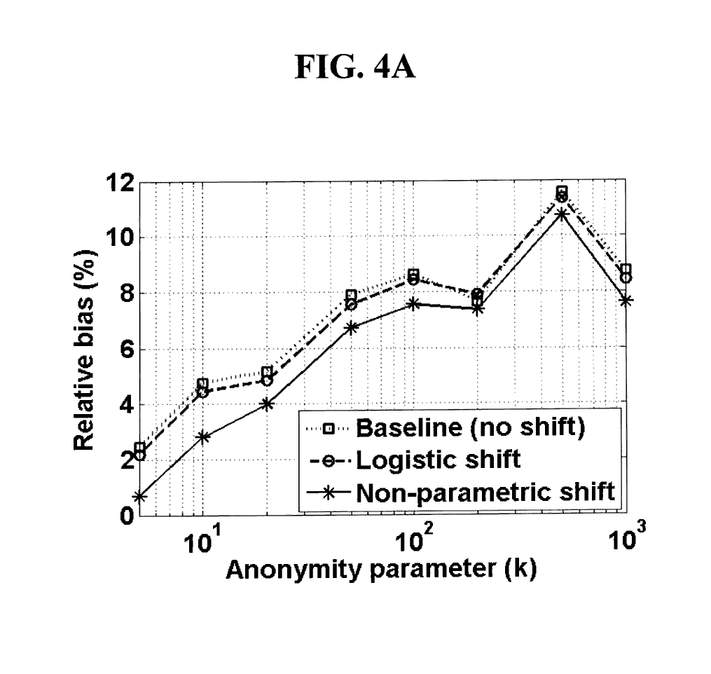

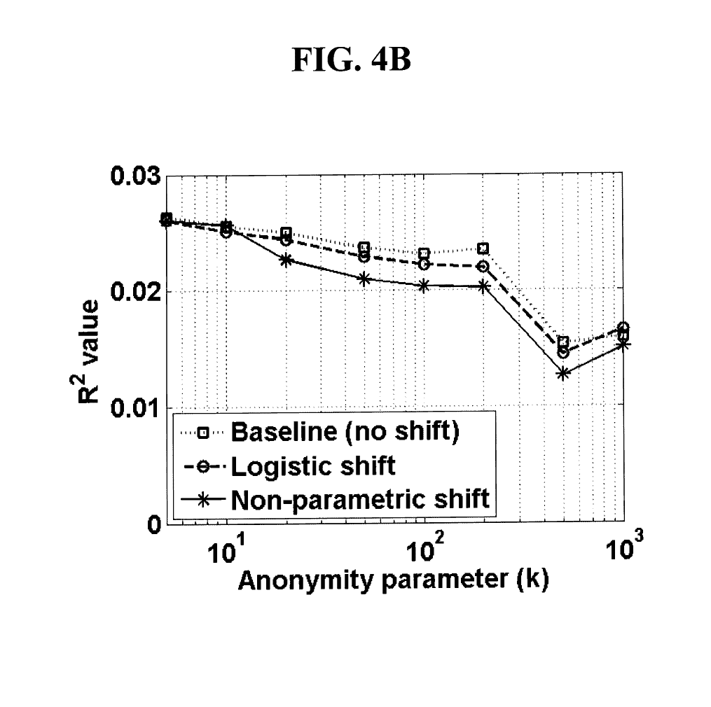

FIG. 4a illustrates prediction bias as a function of an anonymity parameter (k) for baseline, logistic shift and non-parametric shift methods with distribution preservation according to exemplary embodiments of the present invention. FIG. 4b illustrates R² coefficient as a function of an anonymity parameter (k) for baseline, logistic shift and non-parametric shift methods with distribution preservation according to exemplary embodiments of the present invention.

Referring to FIG. 4a and FIG. 4b, as the anonymity parameter k increases, the relationship between X and Y may be distorted and thus prediction bias may increase and R² may decrease. However, as k increases, distribution preservation moderates the bias increase. Bias increase may be a more predictive metric in terms of the impact of distribution preservation than R².

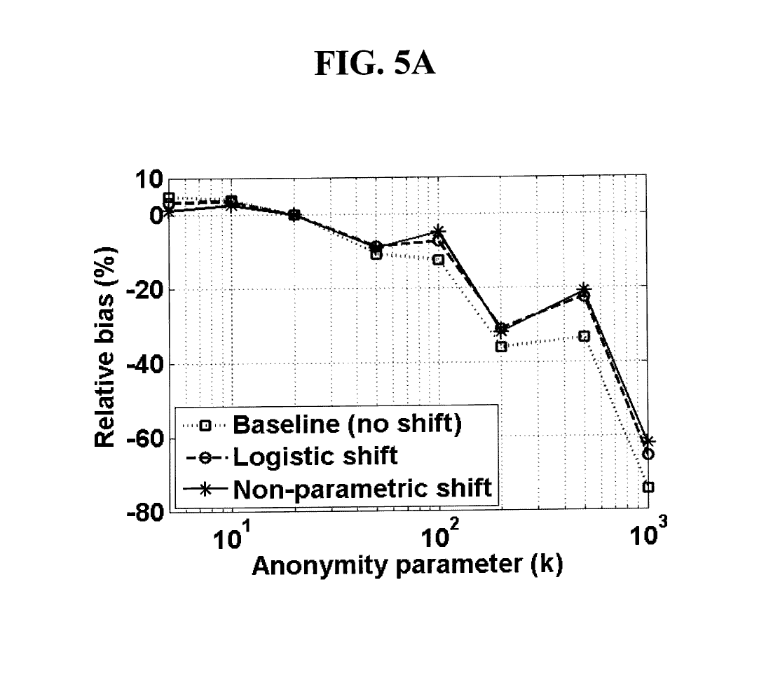

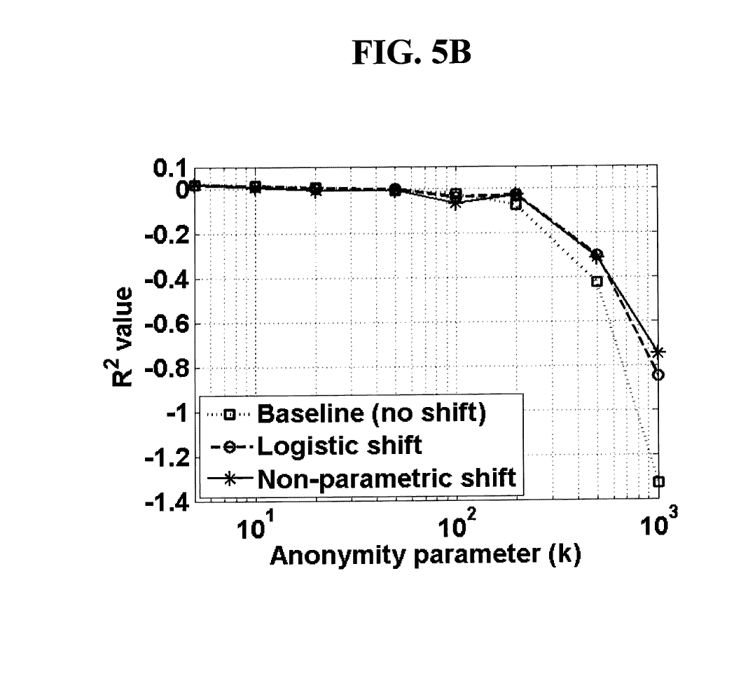

FIG. 5a illustrates prediction bias as a function of an anonymity parameter (k) for baseline, logistic shift and non-parametric shift methods without distribution preservation. FIG. 5b illustrates R² coefficient as a function of an anonymity parameter (k) for baseline, logistic shift and non-parametric shift methods without distribution preservation.

Referring to FIG. 5a and FIG. 5b, as k increases prediction error also increases. The impact of increases in k in FIG. 5a and FIG. 5b illustrates a markedly greater reduction in prediction accuracy when distribution preservation is not performed. Thus, prediction error may increase to an unacceptable level as k increases when distribution preservation according to exemplary embodiments of the present invention is not performed.

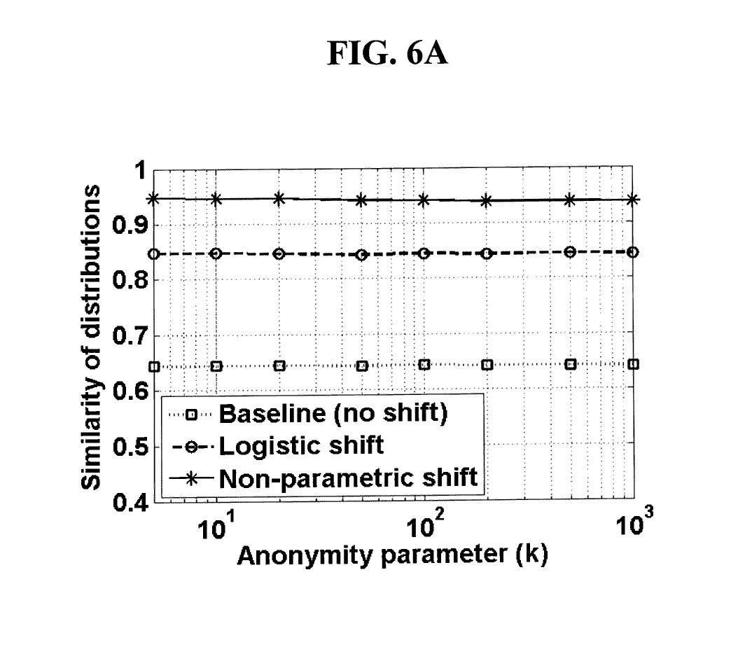

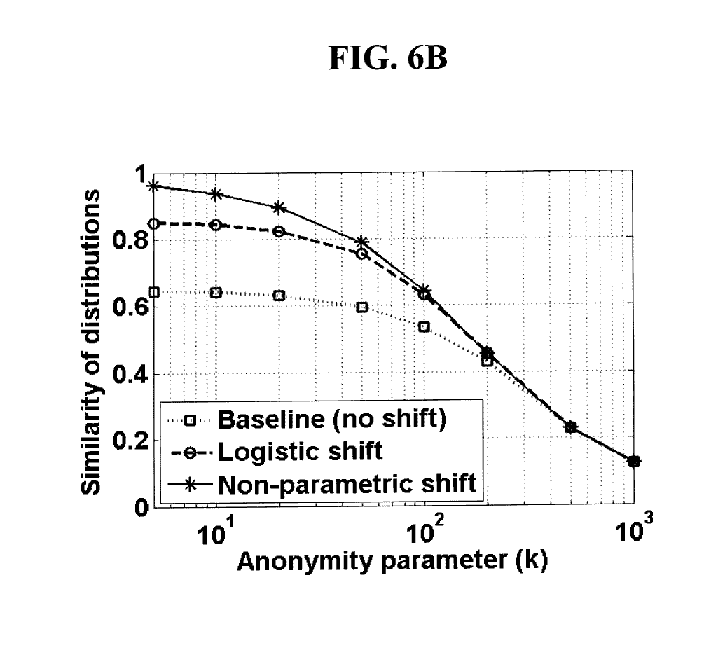

FIG. 6a illustrates a similarity between baseline, logistic shift and non-parametric shift estimated new enrollment distributions with distribution preservation according to exemplary embodiments of the present invention compared with actual new enrollment distributions as a function of an anonymity parameter (k). FIG. 6b illustrates a similarity between baseline, logistic shift and non-parametric shift estimated new enrollment distributions without distribution preservation compared with actual new enrollment distributions as a function of an anonymity parameter (k).

Referring to FIG. 6a and FIG. 6b, a value close to 1 may illustrate that the predictor is trained on a distribution that is the same or similar to one encountered during testing an actual market. Referring to FIG. 6a, using distribution-preserving privacy transformations according to exemplary embodiments of the present invention, the similarity between a market risk prediction and actual market conditions may be kept constant as the anonymity k increases and predictive accuracy may be increased by the covariate shift methods according to exemplary embodiments of the present invention. However, when traditional k-anonymization is employed, as illustrated in FIG. 6b, market risk prediction accuracy declines sharply as k increases.

Table 2 illustrates the predictive accuracy of a basic method that may be commonly used by insurance companies, a linear model (no shift) method which does not account for population shift and the method accounting for population shift according to exemplary embodiments of the present invention in low, medium and high market risk scenarios. The three methods illustrated in Table 2 were evaluated according to method bias (e.g., difference between mean predicted cost and mean actual cost) and mean squared error (R² coefficient). Table 2 illustrates that the method accounting for population shift according to exemplary embodiments of the present invention is more accurate in predicting market risk than the basic or no shift methods.

TABLE 2

| Actual Market | | | |
|---|---|---|---|
| Risk | Basic Method | Full No Shift | Full with Shift |
| Low | 50 | 83 | 100 |
| Medium | 17 | 83 | 100 |
| High | 33 | 100 | 100 |

According to exemplary embodiments of the present invention, predictive accuracy may be maintained while reducing bias. The predictive accuracy and relatively low bias for the methods according to exemplary embodiments of the present invention may be maintained when employing the privacy-preservation methods according to exemplary embodiments of the present invention.

FIG. 7 illustrates an exemplary interactive user dashboard according to exemplary embodiments of the present invention.

Referring to FIG. 7, a flexible range of market risk measures may be presented to a user in a user dashboard 700. For example, market risk measures may be dynamically presented to a user on a computer, tablet or Smartphone. According to an exemplary embodiment of the present invention the statistical model may be used to produce individual-level cost predictions of entering the new market. According to an exemplary embodiment of the present invention the individual-level cost predictions may be aggregated according to user-defined criteria.

For example, the user dashboard 700 may be interactive in that regions of a state could be identified by a particular color when presented on a computing device, the color indicating a level of risk (computed in accordance with an exemplary embodiment of the present invention) associated with entering that particular region. Interaction may involve a user selecting one of the regions in an effort to determine not only the risk score associated with that region, but demographic data of that region. Such data could be used to find comparable regions already serviced by the health care provider. For example, the computing device can access a remote database including regions service by the provider. This information could be used in conjunction with the risk score for a more robust decision process.

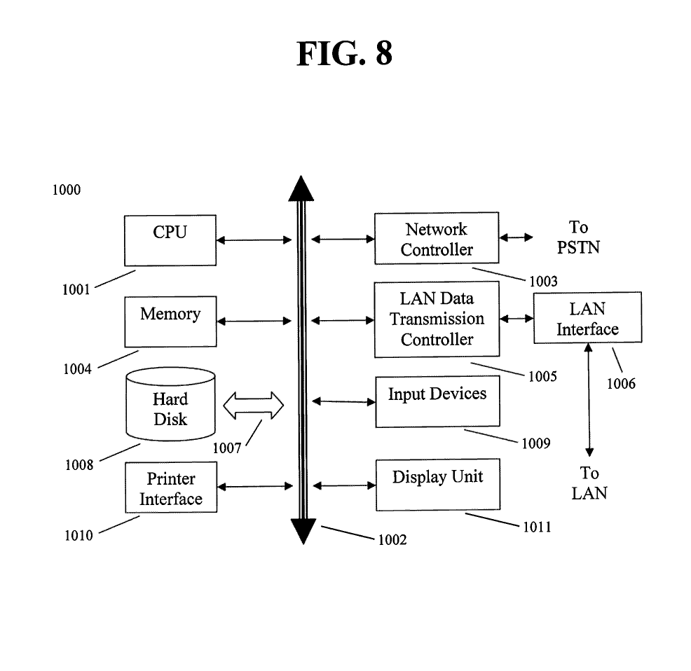

FIG. 8 illustrates an example of a computer system capable of implementing the method and apparatus according to embodiments of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The descriptions of the various exemplary embodiments of the present invention have been presented for purposes of illustration, but are not intended to be exhaustive or limited to the exemplary embodiments disclosed. Many modifications and variations will be apparent to those of ordinary skill in the art without departing from the scope and spirit of the described exemplary embodiments. The terminology used herein was chosen to best explain the principles of the exemplary embodiments, or to enable others of ordinary skill in the art to understand exemplary embodiments described herein.

The flowcharts and/or block diagrams in the figures illustrate the architecture, functionality, and operation of possible implementations of systems, methods, and computer program products according to various exemplary embodiments of the inventive concept. In this regard, each block in the flowchart or block diagrams may represent a module, segment, or portion of instructions, which comprises one or more executable instructions for implementing the specified logical function(s). In alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A computer-based method of health insurance market risk assessment, comprising:
receiving first data, the first data including demographic and cost data for members of a health insurance plan in a current market;
receiving second data, the second data including demographic data for the current market;
receiving third data, the third data including demographic data for a new market;
using the first to third data to transform a distribution of the plan members to account for differences between the current and new market demographic data and estimate probabilities of enrollment in the new market;
learning a statistical model to predict risk in the new market using the transformed distribution and the estimated probabilities; and
using the statistical model to determine risk of entering the new market.

2. The method of claim 1, further comprising performing a privacy-preserving transformation on the first data.

3. The method of claim 2, wherein the privacy-preserving transformation includes a clustering procedure where each cluster contains at least a pre-specified number (k) of members followed by a probability transformation.

4. The method of claim 1, wherein the transform of the distribution of the plan members and the estimate of the probabilities of enrollment in the new market occur at the same time.

5. The method of claim 1, further comprising modifying the estimates of the enrollment probabilities.

6. The method of claim 5, wherein the estimates of the enrollment probabilities are displayed to and modified by a user.

7. The method of claim 1, wherein the statistical model is learned using a non-demographic factor of the new market.

8. The method of claim 1, further comprising using the statistical model to produce individual-level cost predictions of entering the new market.

9. The method of claim 8, further comprising aggregating the individual-level cost predictions according to user-defined criteria.

10. The method of claim 9, wherein the aggregation is performed using a computing device.

11. A computer-based method of health insurance market risk assessment, comprising
transforming a distribution of existing plan members to account for differences between existing and new market demographics while estimating and accounting for probabilities of enrollment in the new market;
learning a statistical model to predict risk in the new market using the transformed distribution and the estimated probabilities; and
using the statistical model to determine risk of entering the new market.

12. The method of claim 11, further comprising:
receiving adjustments to initially estimated enrollment probabilities.

13. The method of claim 12, wherein the adjustment is received from a subject matter expert.

14. The method of claim 11, wherein using the statistical model to determine the risk of entering the new market comprises:
computing individual-level cost predictions.

15. The method of claim 14, further comprising:
aggregating the individual-level cost predictions according to user-defined criteria.

16. The method of claim 15, wherein the aggregated individual-level cost predictions are displayed on a computing device.

17. The method of claim 11, wherein the statistical model includes a plurality of predictive values.

18. The method of claim 11, further comprising:
applying a privacy preservation measure to data indicative of the existing plan members.

19. The method of claim 17, Wherein the privacy preservation measure is applied to the data which has already been removed of personal identifiers.

20. A computer-based method of health insurance market risk assessment, comprising:
aggregate claims of current members of a health insurance plan to estimate demographic distribution of the current members;
for each demographic group in the estimated demographic distribution of the current members, compute aggregate statistics of corresponding health costs;
aggregate demographic data for the current member's market to estimate a demographic distribution of a current market;
aggregate demographic data for a new market to estimate a demographic distribution of the new market;
for each demographic group of the estimated demographic distribution of the current market and the estimated demographic distribution of the new market, compute a ratio of new market distribution;
re-weighting the aggregated claims of the current members and the aggregated statistics of the corresponding health costs using the ratio of new market distribution; and
leaning a model for predicting risk of entering the new market by performing a linear regression of cost on demographic variables using the re-weighted aggregated claims of the current members and the aggregated statistics of the corresponding health costs.

21. The method of claim 20, further comprising:
adjusting predictions made by the learned model by multiplying the predictions with a cost factor for the new market.

22. The method of claim 21, further comprising:
aggregating the adjusted predictions according to pre-defined criteria.

23. The method of claim 22, further comprising:
visually alerting a user to low-risk regions via a computing device using the aggregated adjusted predictions.
